(19) United States
(12) Patent Application Publication
(10) Pub. No.: US 2016/0327190 A1
(43) Pub. Date: Nov. 10, 2016

(54) OXYGEN SENSOR SEAT STRUCTURE

(71) Applicant: Mei-Pin Hsing, Changhua County (TW)

(72) Inventor: Mei-Pin Hsing, Changhua County (TW)

(21) Appl. No.: 14/704,999

(22) Filed: May 6, 2015

(51) Int. Cl. F16L 15/08; G01M 15/10

(52) U.S. Cl. CPC F16L 15/08; G01M 15/104

(57) ABSTRACT

The invention includes a fixing sleeve and a seat set. The fixing sleeve has a connecting portion with an inner thread and is fastened onto an exhaust pipe. The seat set has a connecting end with an outer thread and a sleeve end with an inner thread. The connecting end is screwed to the connecting portion. An inner side of the seat set is coated with a catalytic conversion agent.

### BACKGROUND OF THE INVENTION

1. Technical Field

The invention relates to exhaust pipes of automobiles, particularly to junction between a catalytic converter and exhaust pipe.

2. Related Art

An oxygen sensor is installed in a rear portion of a catalytic converter for detecting functions of catalytic. The oxygen sensor will damage if the catalytic converter is removed. When the engine connecting the exhaust pipe is equipped with an engine control unit (ECU), the ECU cannot judge if the air-fuel ratio is normal or not. An engine warning light in the dashboard will light up. Even the engine may not work normally.

### SUMMARY OF THE INVENTION

An object of the invention is to provide an oxygen sensor seat structure, which can prevent an oxygen sensor from sending unnecessary data to an ECU of engine when an exhaust pipe has been refitted.

Another object of the invention is to provide an oxygen sensor seat structure, which is coated with a catalytic conversion agent to improve exhaust conversion efficiency.

Still another object of the invention is to provide an oxygen sensor seat structure, which can vary to match different requirements.

To accomplish the above objection, the oxygen sensor seat structure of the invention includes a fixing sleeve and a seat set. The fixing sleeve has a connecting portion with an inner thread and is fastened onto an exhaust pipe. The seat set has a connecting end with an outer thread and a sleeve end with an inner thread. The connecting end is screwed to the connecting portion. An inner side of the seat set is coated with a catalytic conversion agent.

### BRIEF DESCRIPTION OF THE DRAWINGS

FIG. 1 is a perspective view of the first embodiment of the invention;

FIG. 2 is an exploded view of the first embodiment of the invention;

FIG. 3 is a cross-sectional view of the first embodiment of the invention;

FIG. 4 is a perspective view of the second embodiment of the invention;

FIG. 5 is a perspective view of the third embodiment of the invention; and

FIG. 6 is a perspective view of the fourth embodiment of the invention.

### DETAILED DESCRIPTION OF THE INVENTION

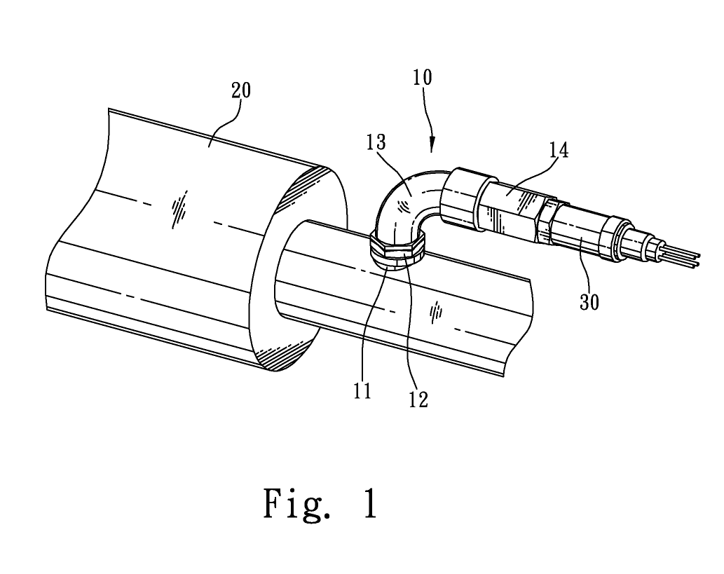

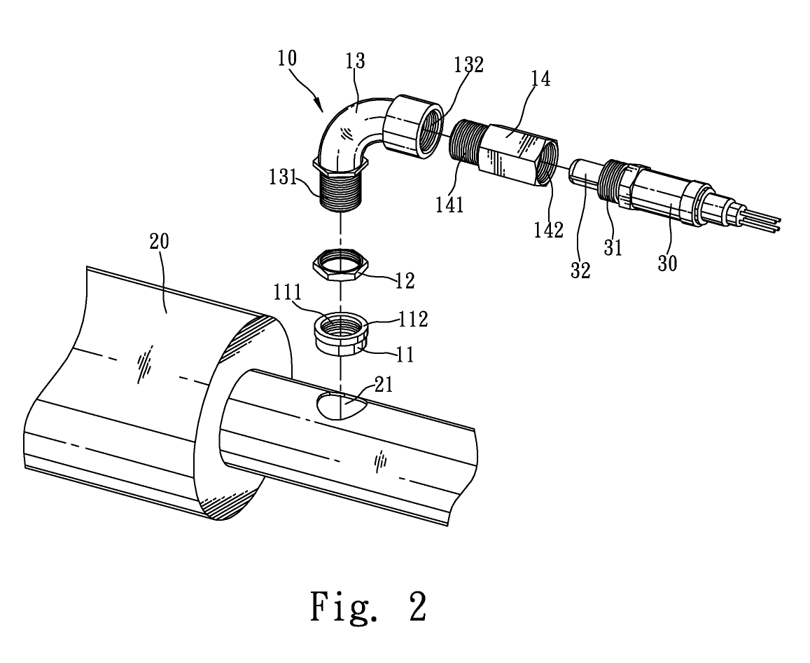

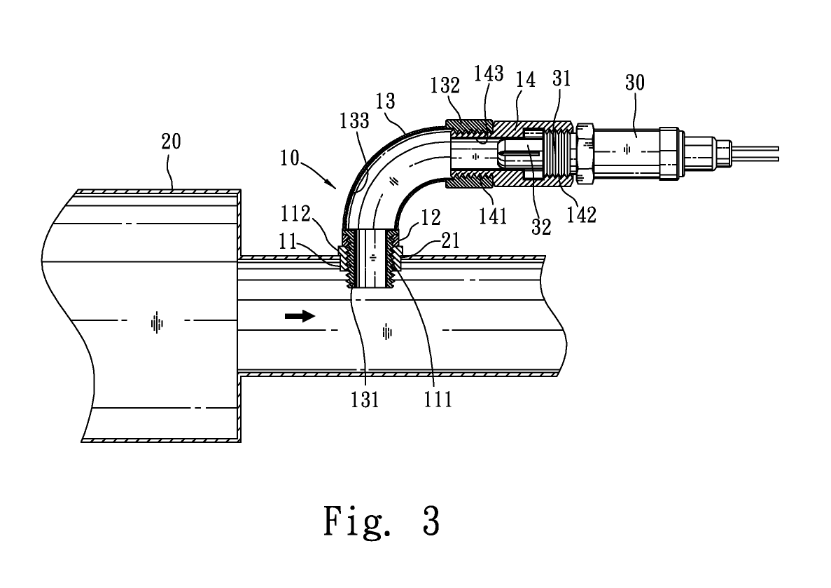

Please refer to FIGS. 1-3. The seat structure 10 of the invention includes a fixing sleeve 11 and a seat set. In the first embodiment, the seat set includes a first seat 13 and a second seat 14. An inner side of the fixing sleeve 11 is a connecting portion 111 with an inner thread. One end of the fixing sleeve 11 is formed with a flange 112. The fixing sleeve 11 is used to fasten into a fixing hole 21 of an exhaust pipe 20 and the flange 112 abuts against an edge of the fixing hole 21.

The first seat 13 is an arc-shaped tube. One end of the first seat 13 is a first connecting end 131 with an outer thread, and the other end thereof is a first sleeve end 132 with an inner thread. An inner side of the first seat 13 is coated with a catalytic conversion agent 133. A nut 12 is screwed onto the first connecting end 131 and abuts against the flange 112. The first seat 13 is fastened to the fixing sleeve 11 by screwing the first connecting end 131 to the nut 12 and the connecting portion 111. When the first seat 13 needs to be angled, the first seat 13 may be adjusted to a required position first and then tighten the nut 12 to press the fixing sleeve 11. Thus the first seat 13 can be positioned.

The second seat 14 is a straight tube. One end of the second seat 14 is a second connecting end 141 with an outer thread, and the other end thereof is a second sleeve end 142 with an inner thread. An inner side of the second seat 14 is coated with a catalytic conversion agent 143. The second seat 14 is fastened to the first seat 13 by screwing the second connecting end 141 to the first sleeve end 132.

When assembling an oxygen sensor 30, because an end of the oxygen sensor 30 has an outer thread 31 and a sensing end 32, the outer thread 31 of the oxygen sensor 30 is screwed into the second sleeve end 142 of the second seat 14. Thus the sensing end 32 is cloaked by the second seat 14. The oxygen sensor 30 will not send unnecessary data to an engine control unit (ECU) because the oxygen sensor 30 is not influenced by the exhaust flow in the exhaust pipe 20.

Furthermore, the first and second seats 13, 14 are coated with catalytic conversion agents 133, 143, so they can replace a catalytic converter.

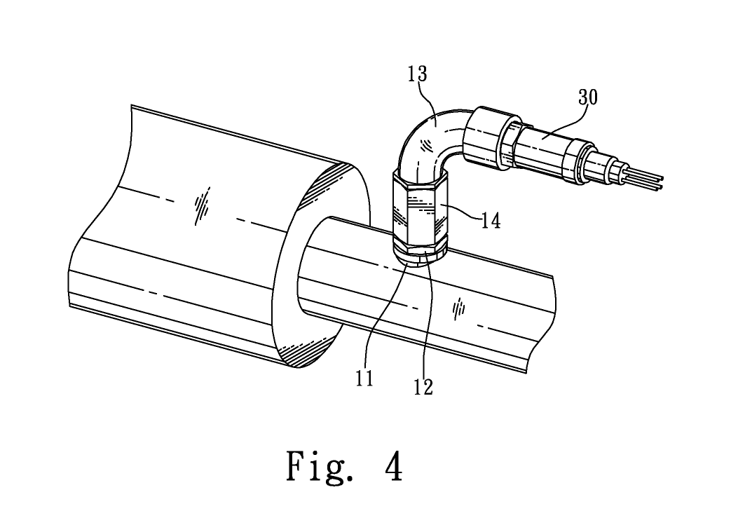

Please refer to FIG. 4, which shows the second embodiment of the invention. In this embodiment, the first and second seats 13, 14 are changed in position. In detail, the second seat 14 is fastened to the exhaust pipe 20 and the first seat 13 is screwed to the second seat 14. Finally, the oxygen sensor 30 is screwed to the first sleeve end 132 of the first seat 13.

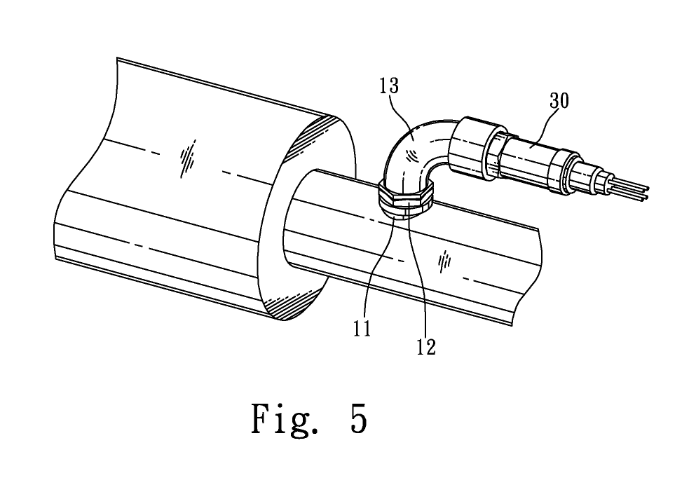

Please refer to FIG. 5, which shows the third embodiment of the invention. In this embodiment, the first seat 13 is individually used. In detail, the first seat 13 is fastened to the exhaust pipe 20 and the oxygen sensor 30 is screwed to the first sleeve end 132 of the first seat 13.

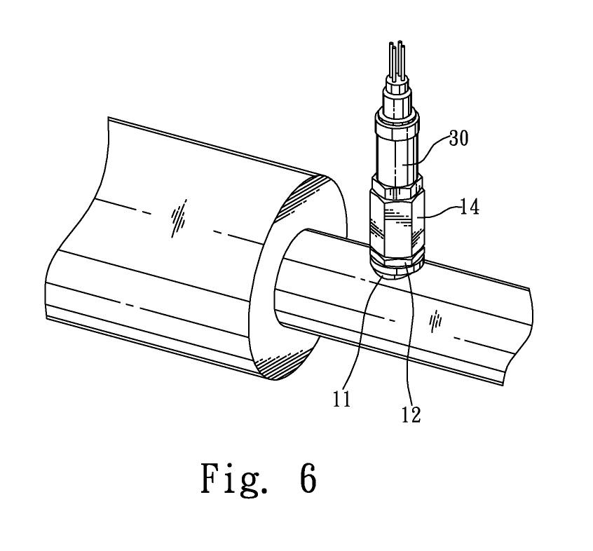

Please refer to FIG. 6, which shows the fourth embodiment of the invention. In this embodiment, the second seat 14 is individually used. In detail, the second seat 14 is fastened to the exhaust pipe 20 and the oxygen sensor 30 is screwed to the second sleeve end 142 of the second seat 14.

It will be appreciated by persons skilled in the art that the above embodiments have been described by way of example only and not in any limitative sense, and that various alterations and modifications are possible without departure from the scope of the invention as defined by the appended claims.

What is claimed is:

1. An oxygen sensor seat structure, comprising:
a fixing sleeve, having a connecting portion with an inner thread, and fastened onto an exhaust pipe; and
a seat set, having a connecting end with an outer thread and a sleeve end with an inner thread, wherein the connecting end is screwed to the connecting portion, an inner side of the seat set is coated with catalytic conversion agent.

2. The oxygen sensor seat structure of claim 1, wherein the fixing sleeve is formed with a flange.

3. The oxygen sensor seat structure of claim 1, wherein the seat set includes a first seat and a second seat, the first seat is an arc-shaped tube, one end of the first seat is a first connecting end with an outer thread, another end thereof is a first sleeve end with an inner thread, the first seat is fastened to the fixing sleeve by screwing the first connecting end to the connecting portion, the second seat is a straight tube, one end of the second seat is a second connecting end with an outer thread, another end thereof is a second sleeve end with an inner thread, and the second seat is fastened to the first seat by screwing the second connecting end to the first sleeve end.

4. The oxygen sensor seat structure of claim 3, wherein the first connecting end of the first seat is screwed with a nut.

5. The oxygen sensor seat structure of claim 1, wherein the seat set includes a first seat and a second seat, the first seat is an arc-shaped tube, one end of the first seat is a first connecting end with an outer thread, another end thereof is a first sleeve end with an inner thread, the second seat is a straight tube, one end of the second seat is a second connecting end with an outer thread, another end thereof is a second sleeve end with an inner thread, the second seat is fastened to the first seat by screwing the first connecting end to the second sleeve end, and the second seat is fastened to the fixing sleeve by screwing the second connecting end to the connecting portion.

6. The oxygen sensor seat structure of claim 5, wherein the second connecting end of the second seat is screwed with a nut.

7. The oxygen sensor seat structure of claim 1, wherein the seat set includes a first seat, the first seat is an arc-shaped tube, one end of the first seat is a first connecting end with an outer thread, another end thereof is a first sleeve end with an inner thread, and the first seat is fastened to the fixing sleeve by screwing the first connecting end to the connecting portion.

8. The oxygen sensor seat structure of claim 7, wherein the first connecting end of the first seat is screwed with a nut.

9. The oxygen sensor seat structure of claim 1, wherein the seat set includes a second seat, the second seat is a straight tube, one end of the second seat is a second connecting end with an outer thread, another end thereof is a second sleeve end with an inner thread, the second seat is fastened to the fixing sleeve by screwing the second connecting end to the connecting portion.

10. The oxygen sensor seat structure of claim 9, wherein the second connecting end of the second seat is screwed with a nut.
